(19) United States
(12) Patent Application Publication
(10) Pub. No.: US 2015/0141549 A1
(43) Pub. Date: May 21, 2015

(54) ANTIBIOTIC PARTICLES AND PRODUCTION METHOD THEREOF

(71) Applicant: Japan EnviroChemicals, Ltd., Osaka-shi, Osaka (JP)

(72) Inventors: Junji Oshima, Osaka-shi (JP); Takayuki Sugiyama, Osaka-shi (JP)

(21) Appl. No.: 14/413,769

(22) PCT Filed: Jun. 27, 2013
(86) PCT No.: PCT/JP2013/067735

§ 371 Date: Jan. 9, 2015

(30) Foreign Application Priority Data
Jul. 13, 2012 (JP) 2012-157569

(51) Int. Cl. C09D 5/14; C08K 5/205; C09D 163/00; C09D 7/12

(52) U.S. Cl. CPC C09D 5/14; C09D 7/1233; C08K 5/205; C09D 163/00
USPC 523/456

(57) ABSTRACT

In antibiotic particles, an antibiotic compound is dispersed in a polymer containing an epoxy group.

### TECHNICAL FIELD

The present invention relates to antibiotic particles and a production method thereof.

### BACKGROUND ART

Recently, it has been known that by allowing a composition containing an antibiotic compound such as a sterilizer, an antiseptic, and a fungicide to contain an epoxy compound, decomposition of the antibiotic compound is decreased and long-term stable antibiotic activities are exhibited.

For example, Patent Document 1 below has proposed a stabilized microorganism antiproliferative composition containing, for example, haloacetylene compounds, isothiazoline compounds, and epoxy compounds.

### CITATION LIST

### Patent Documents

Patent Document 1 Japanese Unexamined Patent Publication No. 2003-104801

### SUMMARY OF THE INVENTION

### Problem to be Solved by the Invention

However, in the microorganism antiproliferative composition described in Patent Document 1, the epoxy compound has a relatively low molecular weight, and therefore low in safety for a living body. Therefore, there are disadvantages in that there are working environment problems and low safety of various industrial products to which the microorganism antiproliferative composition is applied (blended) for a living body.

Furthermore, antibiotic compounds such as haloacetylene compounds and isothiazoline compounds may be easily discolored when stored under exposure to ultraviolet rays for a long period of time. In such a case, excellent appearance may not be achieved.

An object of the present invention is to provide antibiotic particles that achieve excellent working environment, are highly safe for a living body even when applied (blended) to an industrial product, and have excellent appearance after storage for a long period of time; and a production method thereof.

### Means for Solving the Problem

The present inventors conducted energetic study on the above-described antibiotic particles and production method thereof, and found out that by dispersing an antibiotic compound in a polymer containing an epoxy group, the following antibiotic particles can be achieved: working environment problems and decrease in safety for a living body of various industrial products to which the antibiotic particles are applied (blended) due to low safety of the epoxy compound are improved, and also coloration can be suppressed even after a long-term storage. As a result of further conducting the study, present inventors completed the present invention.

The present invention relates to:

(1) antibiotic particles in which an antibiotic compound is dispersed in a polymer containing an epoxy group;
(2) the antibiotic particles of (1) above, wherein the polymer is produced by polymerizing a monomer component containing an epoxy group-containing monomer;
(3) antibiotic particles produced by dispersing a hydrophobic solution containing an antibiotic compound and a monomer component containing an epoxy group-containing monomer in water, and polymerizing the monomer component; and
(4) a method for producing antibiotic particles including dispersing a hydrophobic solution containing an antibiotic compound and a monomer component containing an epoxy group-containing monomer in water; and polymerizing the monomer component.

### Effect of the Invention

In the antibiotic particles of the present invention, the polymer contains an epoxy group, and therefore working environment problems and decrease in safety for a living body of various industrial products to which the antibiotic particles of the present invention are applied (blended) due to the epoxy group are improved, and therefore the working environment is excellent and safety for a living body of the industrial products to which the antibiotic particles of the present invention are applied (blended) is high.

In the antibiotic particles of the present invention, the antibiotic compound is dispersed in the polymer containing an epoxy group, and therefore discoloration on the antibiotic compound can be suppressed, and appearance of the antibiotic particles after long-term storage is excellent. Particularly, discoloration due to exposure to ultraviolet rays can be decreased.

In a method for producing antibiotic particles of the present invention, the polymer contains an epoxy group, and the antibiotic compound is dispersed in the polymer containing an epoxy group, and therefore the following antibiotic particles can be obtained: working environment problems and decrease in safety for a living body of various industrial products to which the present invention is applied (blended) due to the epoxy group are improved, and excellent appearance even after a long term storage can be achieved. Particularly, discoloration due to exposure to ultraviolet ray can be decreased.

### EMBODIMENT OF THE INVENTION

Antibiotic particles of the present invention contain a polymer containing an epoxy group, and an antibiotic compound dispersed in the polymer.

In the present invention, the state in which the antibiotic compound is dispersed in the polymer includes the following: the antibiotic compound is miscible with (dissolved in) the polymer (that is, the antibiotic compound and the polymer form a homogeneous phase ((although to be described later, to be specific, a homogeneous phase having a composition ratio that is the same as the ratio of the antibiotic compound to the polymer charged)), and/or the state in which the antibiotic compound is present homogeneously or inhomogeneously in the polymer, like a two-phase separation structure (sea-island structure). Furthermore, the state in which the antibiotic compound is dispersed in the polymer may include the state in which the above-described homogenous phase is contained partially, for example, the state in which the core in the core-shell structure to be described later forms a homogenous phase.

The polymer containing an epoxy group includes a polymer having an epoxy group chemically bonded thereto, and to be more specific, includes a polymer having an epoxy group covalently bonded thereto.

The polymer of the present invention is produced, for example, by polymerizing a monomer component.

The monomer component is in a liquid state under normal temperature, and contains an epoxy group-containing monomer.

Examples of the epoxy group-containing monomer include an epoxy group-containing polymerizable vinyl monomer having at least one epoxy group and at least one polymerizable carbon-carbon double bond in its molecule.

Examples of the epoxy group-containing polymerizable vinyl monomer include an epoxy group-containing (meth)acrylate monomer, and an epoxy group-containing ether monomer.

The epoxy group-containing (meth)acrylate monomer is, for example, methacrylate and/or acrylate containing an epoxy group, and to be specific, examples thereof include glycidyl (meth)acrylate (GA/GMA), hydroxybutyl acrylate glycidyl ether, and (meth)acrylic acid 2-methyloxiranylmethyl ether, and preferably, glycidyl (meth)acrylate is used.

Examples of the epoxy group-containing ether monomer include straight chain, branched or cyclic epoxy group-containing aliphatic ether monomer such as vinylglycidylether, allylglycidylether, isopropenylglycidylether, and 4-vinylcyclohexylglycidylether; and epoxy group-containing aromatic ether monomer such as 3-vinylbenzylglycidylether, and 4-vinyl benzylglycidylether.

Of the examples of the epoxy group-containing monomer, preferably, epoxy group-containing (meth)acrylate monomers are used.

These epoxy group-containing monomers may be used singly, or may be used in combination of two or more.

The monomer component may contain, in addition to the epoxy group-containing monomer, an epoxy group-noncontaining monomer that is copolymerizable with the epoxy group-containing monomer.

Examples of the epoxy group-noncontaining monomer include an epoxy group-noncontaining polymerizable vinyl monomer that does not contain an epoxy group and has at least one polymerizable carbon-carbon double bond in its molecule.

Examples of the epoxy group-noncontaining polymerizable vinyl monomer include (meth)acrylate monomers, (meth)acrylic acid monomers, aromatic vinyl monomers, ether monomers, vinyl ester monomers, maleate monomers, vinyl halide monomers, nitrogen-containing vinyl monomers, polymerization reactive ultraviolet absorbers, and polymerization reactive emulsifiers.

Examples of the (meth)acrylate monomer include methacrylate and/acrylate, to be specific, alkyl (meth)acrylate having an alkyl moiety of a straight chain or branched aliphatic group with 1 to 20 carbon atoms, such as methyl (meth)acrylate, ethyl (meth)acrylate, n-propyl (meth)acrylate, iso-propyl (meth)acrylate, n-butyl (meth)acrylate (n-BA/n-BMA), iso-butyl (meth)acrylate (i-BA/i-BMA), tert-butyl (meth)acrylate, n-pentyl (meth)acrylate, n-hexyl (meth)acrylate, n-heptyl (meth)acrylate, 2-ethylhexyl (meth)acrylate, iso-nonyl (meth)acrylate, n-decyl (meth)acrylate, n-dodecyl (meth)acrylate, n-hexadecyl (meth)acrylate, and n-octadecyl (meth)acrylate; and cycloalkyl (meth)acrylate having an alkyl moiety of a cyclic aliphatic group with 3 to 20 carbon atoms, such as cyclopentyl (meth)acrylate, cyclohexyl (meth)acrylate, and cycloheptyl (meth)acrylate.

Examples of the (meth)acrylate monomer also include hydroxyl group-containing (meth)acrylate in which the hydrogen atoms in the alkyl moiety are replaced with hydroxyl groups in the above-described monomer, and which has a hydroxyalkyl moiety with 2 to 10 carbon atoms, to be specific, 2-hydroxyethyl (meth)acrylate, 3-hydroxypropyl (meth)acrylate, 4-hydroxybutyl (meth)acrylate, and 6-hydroxyhexyl (meth)acrylate.

For the (meth)acrylate monomer, preferably, alkyl (meth)acrylate having an alkyl moiety of a straight chain or branched aliphatic group with 1 to 6 carbon atoms (preferably, 1 to 3 carbon atoms or 4 to 6 carbon atoms) is used.

Examples of the (meth)acrylic acid monomer include methacrylic acid (MAA), acrylic acid, and itaconic acid.

Examples of the aromatic vinyl monomer include styrene, 4-chlorostyrene, p-methyl styrene, o-methyl styrene, and α-methyl styrene.

Examples of the ether monomer include vinyl ether such as ethylvinyl ether and n-butylvinyl ether.

Examples of the vinyl ester monomer include vinyl acetate and vinyl propionate.

Examples of the maleate monomer include dimethyl maleate, diethyl maleate, and dibutyl maleate.

Examples of the vinyl halide monomer include vinyl chloride and vinyl fluoride. Examples of the vinyl halide monomer also include vinylidene halide monomers, to be specific, vinylidene chloride and vinylidene fluoride.

Examples of the nitrogen-containing vinyl monomer include (meth)acrylonitrile, N-phenylmaleimide, and vinylpyridine.

The polymerization reactive ultraviolet absorber is a monomer having an ultraviolet ray absorbing group and a polymerizable carbon-carbon double bond in its molecule. Examples of the ultraviolet ray absorbing group include ultraviolet ray absorbing groups such as benzotriazole ring and phenol. Examples of the polymerization reactive ultraviolet absorber include 2-[3-(2H-benzotriazole-2-yl)-4-hydroxyphenyl]ethyl (meth)acrylate. For the polymerization reactive ultraviolet absorber, for example, commercially available products can be used, including, for example, RUVA series (manufactured by Otsuka Chemical Co., Ltd.).

The polymerization reactive emulsifier is an emulsifier having a polymerizable carbon-carbon double bond in its molecule, and is an emulsifier and at the same time is a polymerizable monomer. The polymerization reactive emulsifier has a hydrophilic group that exhibits emulsification functions in its molecule, and examples of such a hydrophilic group include anionic hydrophilic groups such as sulfonate groups and carboxylate groups; and nonionic hydrophilic groups such as polyoxyethylene group. For the polymerization reactive emulsifier, preferably, those having both an anionic hydrophilic group and a nonionic hydrophilic group; having only an anionic hydrophilic group; and having only a nonionic hydrophilic groups are used. Particularly preferably, those having both an anionic hydrophilic group and a nonionic hydrophilic group are used, and examples of such having both an anionic hydrophilic group and a nonionic hydrophilic group include, to be specific, CH₂═C(CH₃)—COO(AO)ₙSO₃Na (where AO represents alkylene oxide such as ethylene oxide and propylene oxide), and CH₂═C(CH₃)—C₆H₄(CₙH₂ₙ₊₁)-(AO)ₘSO₃NH₄ (where AO represents alkylene oxide such as ethylene oxide and propylene oxide). Examples of such having only a nonionic hydrophilic group include, to be specific, CH₂═C(CH₃)—COO(AO)ₙR (where AO represents alkylene oxides such as ethylene oxide and propylene oxide, and R represents an alkyl group) and CH₂═C(CH₃)—C₆H₄(CH₂H₂ₙ₊₁)-(AO)ₘH (where AO represents alkylene oxides such as ethylene oxide and propylene oxide). For the polymerization reactive emulsifier, for example, commercially available products can also be used, and for example, ELEMINOL series (manufactured by Sanyo Chemical Industries), SANMORIN series (manufactured by Sanyo Chemical Industries), CARRYBON series (manufactured by Sanyo Chemical Industries), EMULMIN series (manufactured by Sanyo Chemical Industries), NAROACTY series (manufactured by Sanyo Chemical Industries), Aquaron series (manufactured by Dai-ichi Kogyo Seiyaku Co., Ltd.), LATEMUL series (manufactured by Kao Chemicals), REASOAP series (manufactured by ADEKA Corporation), ANTOX series (manufactured by Nippon Nyukazai Co., Ltd.), and BLEMMER series (manufactured by NOF CORPORATION) are used.

For the epoxy group-noncontaining polymerizable vinyl monomer, preferably, (meth)acrylate monomers, (meth)acrylic acid monomer, polymerization reactive ultraviolet absorbers, and polymerization reactive emulsifiers are used.

When the epoxy group-noncontaining polymerizable vinyl monomer contains (meth)acrylate monomer (to be specific, n-BA, etc.) other than MMA, the glass transition temperature of the copolymer can be decreased.

When the epoxy group-noncontaining polymerizable vinyl monomer contains (meth)acrylic acid monomer, the carboxyl group and/or carboxylate group of the (meth)acrylic acid monomer are distributed on the surface of the controlled-release particles, and colloid stability in the controlled-release particles emulsion can be improved.

When the epoxy group-noncontaining polymerizable vinyl monomer contains the polymerization reactive ultraviolet absorber, coloration on the antibiotic particles due to ultraviolet rays can be more suppressed.

When the epoxy group-noncontaining polymerizable vinyl monomer contains the polymerization reactive emulsifier, the mixing ratio of the emulsifier to be described later can be decreased, stability of the monomer component at the time of polymerization and/or storage can be improved, and furthermore, stability when mechanical shearing force is loaded can be improved.

These epoxy group-noncontaining polymerizable vinyl monomers can be used singly, or can be used in combination of two or more.

When the epoxy group-noncontaining polymerivable vinyl monomer is used in combination, preferably, (meth)acrylate monomer and (meth)acrylic acid monomer are used in combination, (meth)acrylate monomer and a polymerization reactive ultraviolet absorber are used in combination, or (meth)acrylate monomer and a polymerization reactive emulsifier are used in combination. When the (meth)acrylate monomer and the (meth)acrylic acid monomer are used in combination, the mixing ratio of the (meth)acrylic acid monomer relative to 100 parts by mass of the epoxy group-noncontaining polymerizable vinyl monomer is, for example, 60 parts by mass or less, preferably 50 parts by mass or less, and for example, 0.1 parts by mass or more, preferably 1 part by mass or more. When the (meth)acrylate monomer and the polymerization reactive ultraviolet absorber are used in combination, the mixing ratio of the polymerization reactive ultraviolet absorber relative to 100 parts by mass of the epoxy group-noncontaining polymerizable vinyl monomer is, for example, 25 parts by mass or less, preferably 15 parts by mass or less, and for example, 0.5 parts by mass or more, preferably 1 part by mass or more. When the (meth)acrylate monomer and the polymerization reactive emulsifier are used in combination, the mixing ratio of the polymerization reactive emulsifier relative to 100 parts by mass of the epoxy group-noncontaining polymerizable vinyl monomer is, for example, 25 parts by mass or less, preferably 10 parts by mass or less, and for example, 0.1 parts by mass or more, preferably 0.5 parts by mass or more.

When the epoxy group-containing monomer and the epoxy group-noncontaining monomer are used in combination as the monomer component, the mixing ratio of the epoxy group-containing monomer relative to 100 parts by mass of the monomer component (total amount of the epoxy group-containing monomer and the epoxy group-noncontaining monomer) is, for example, less than 50 parts by mass, preferably 40 parts by mass or less, and for example, 1 part by mass or more, preferably 10 parts by mass or more. Meanwhile, the mixing ratio of the epoxy group-noncontaining monomer relative to 100 parts by mass of the monomer component is, for example, more than 50 parts by mass, preferably, 60 parts by mass or more, and for example, 99 parts by mass or less, preferably 90 parts by mass or less.

When the mixing ratio of the epoxy group-containing monomer is the above-described upper limit or less, production costs of the controlled-release particles can be decreased, and coloration on the controlled-release particles can be more suppressed. Meanwhile, when the mixing ratio of the epoxy group-containing monomer is the above-described lower limit or more, coloration of the controlled-release particles can be more suppressed.

Of the above-described epoxy group-containing monomer and epoxy group-noncontaining monomer, for example, an antibiotic compound-miscible monomer (hereinafter, may be simply referred to as miscible monomer) that is highly miscible with the antibiotic compound, and is capable of dissolving (miscible) the antibiotic compound is selected.

These miscible monomers can be used singly or in combination of two or more.

For the miscible monomer, for example, the epoxy group-containing monomer is used singly, or the epoxy group-containing monomer is used in combination with the epoxy group-noncontaining monomer. For the miscible monomer, preferably, the epoxy group-containing (meth)acrylate monomer is used singly; the epoxy group-containing (meth)acrylate monomer and the (meth)acrylate monomer are used in combination; or the epoxy group-containing (meth)acrylate monomer, (meth)acrylate monomer, and (meth)acrylic acid monomer are used in combination.

In view of suppressing coloration of the controlled-release particles even more, preferably, the epoxy group-containing (meth)acrylate monomer and the (meth)acrylate monomer are used in combination, or the epoxy group-containing (meth)acrylate monomer, the (meth)acrylate monomer, and the (meth)acrylic acid monomer are used in combination, and more preferably, the epoxy group-containing (meth)acrylate monomer and the (meth)acrylate monomer are used in combination.

The miscible monomer is selected so that the miscible monomer is miscible with (is dissolved in) the antibiotic compound at the polymerization temperature (heating temperature) to be described later.

The epoxy group-noncontaining monomer can also contain a crosslinkable monomer as the miscible monomer.

The crosslinkable monomer is blended as necessary to adjust the controlled release (described later) of the antibiotic compound, and solvent resistance and/or physical strength of the antibiotic particles, and examples thereof include mono or polyethylene glycol di(meth)acrylate such as ethylene glycol di(meth)acrylate (EGDMA/EGDA) and diethylene glycol di(meth)acrylate; alkane diol di(meth)acrylate such as 1,3-propanediol di(meth)acrylate, 1,4-butanediol di(meth)acrylate, and 1,5-pentanediol di(meth)acrylate; alkane polyol poly (meth)acrylate such as trimethylolpropane tri(meth)acrylate and pentaerythritol tetra(meth)acrylate; allyl monomers such as allyl (meth)methacrylate, and triallyl (iso)cyanurate; and divinyl monomers such as divinylbenzene. Preferably, mono or polyethylene glycol di(meth)acrylate is used.

For the crosslinkable monomer, a monomer having a molecular structure similar to the molecular structure of the miscible monomer excluding the crosslinkable monomer is selected to ensure miscibility of the monomer component containing the crosslinkable monomer with the antibiotic compound, and to be specific, when the miscible monomer excluding the crosslinkable monomer contains the (meth)acrylate monomer, mono or polyethylene glycol di (meth)acrylate is selected as the crosslinkable monomer.

The mixing ratio of the crosslinkable monomer relative to 100 parts by mass of the monomer component is, for example, 5 parts by mass or more, preferably 10 parts by mass or more, even more preferably 30 parts by mass or more, and for example, 95 parts by mass or less, preferably 90 parts by mass or less, even more preferably 60 parts by mass or less.

The monomer component is substantially hydrophobic, to be specific, for example, its solubility to water under room temperature is extremely low, to be more specific, its solubility under room temperature is, for example, 10 parts by mass/i 100 part by mass of water or less, preferably, 8 parts by mass/100 part by mass of water or less.

The monomer component produces a polymer having a polar term δ_{p,polymer} of, for example, 5.0 to 7.0[(J/cm³)^{1/2}], preferably 5.0 to 6.5[(J/cm³)^{1/2}] of solubility parameter δ, and a hydrogen bonding term δ_{h,polymer} of, for example, 8.0 to 10.0[(J/cm³)^{1/2}], preferably 8.5 to 10.0[(J/cm³)^{1/2}], more preferably 9.0 to 10.0[(J/cm³)^{1/2}] of solubility parameter δ, the solubility parameter δ being defined by Hansen and calculated by van Krevelen and Hoftyzer method.

Polar term δ_{p,polymer} and hydrogen bonding term δ_{h,polymer} of the polymer are described in detail in, for example, Japanese Unexamined Patent Publication No. 2011-79816, and calculation is performed in accordance with the description.

The antibiotic compound is selected from, for example, a sterilizer, an antibacterial agent, an antiseptic, an antialgae, a fungicide, an insecticide (e.g., pyriproxyfen, etc.), a herbicide (e.g., Pyraclonil, Pendimethalin, Indanofan, etc.), an attractant, a repellent (e.g., Deet, etc.), a rodenticide, etc. having antibiotic activities such as, for example, sterilizing, antibacterial, antiseptic, antialgae, antifungal, and insecticidal activity. Examples of these compounds having antibiotic activity include sterilizing antiseptic antialgae fungicides such as an iodine compound, a triazole compound, a carbamoyl imidazole compound, a dithiol compound, an isothiazoline compound, a nitro alcohol compound, and p-hydroxybenzoate ester; and termite control agents (termite killers) such as a pyrethroid compound, a neonicotinoid compound, an organic chlorine compound, an organic phosphorus compound, a carbamate compound, an alkoxyamine compound, and an oxadiazon compound.

Examples of the iodine compound include 3-iodo-2-propynylbutylcarbamate (IPBC), 1-[[(3-iodo-2-propynyl)oxy]methoxy]-4-methoxybenzene, and 3-bromo-2,3-diiodo-2-propenyl ethyl carbonate.

Examples of the triazole compound include 1-[2-(2,4-dichlorophenyl)-4-n-propyl-1,3-dioxolane-2-ylmethyl]-1H-1,2,4-triazole (propiconazole), and bis(4-fluorophenyl) methyl (1H-1,2,4-triazole-1-ylmethylsliane) (also called: flusilazole, 1-[[bis(4-fluorophenyl)methylsilyl]methyl]-1H-1,2,4-triazole).

Examples of the carbamoyl imidazole compound include N-propyl-N-[2-(2,4,6-trichloro-phenoxy)ethyl]imidazole-1-carboxamide (prochloraz).

Examples of the dithiol compound include 4,5-dichloro-1,2-dithiol-3-one.

Examples of the isothiazoline compound include 2-n-octyl-4-isothiazoline-3-one (OIT), 5,6-dichloro-2-n-octyl-4-isothiazoline-3-one (DCOIT), and 5-chloro-2-methyl-4-isothiazoline-3-one (Cl-MIT).

Examples of the nitro alcohol compound include 2,2-dibromo-2-nitro-1-ethanol (DBNE).

Examples of the p-hydroxybenzoate include butyl p-hydroxybenzoate and propyl p-hydroxybenzoate.

Examples of the pyrethroid compound include pyrethrin obtained from pyrethrum, cinerin, and jasmoline; and also include allethrin, bifenthrin, acrinathrin, α-cypermethrin, tralomethrin, cyfluthrin ((RS)-α-cyano-4-fluoro-3-phenoxybenzyl-(1 RS,3RS)-(1RS,3RS)-3-(2,2-dichlorovinyl)-2,2-dimethylcyclopropane carboxylate), cyphenothrin, prallethrin, ethofenprox, silafluofen, and fenvalerate derived therefrom.

Examples of the neonicotinoid compound include (E)-N¹-[(6-chloro-3-pyridyl)methyl]-N²-cyano-N¹-methylacetamidine (acetamiprid).

Examples of the organic chlorine compound include Kelthane.

Examples of the organic phosphorus compound include phoxim, pyridaphenthion, fenitrothion, tetrachlorvinphos, dichlofenthion, and propetamphos.

Examples of the carbamate compound include fenobucarb and propoxur.

Examples of the alkoxyamine compound include 3-lauryloxypropylamine.

Examples of the oxadiazon compound include indoxacarb.

For the antibiotic compound, preferably, iodine compound, more preferably IPBC is used.

The antibiotic compound has a melting point of, for example, 100° C. or less, preferably 90° C. or less, even more preferably 80° C. or less, and is substantially hydrophobic. To be specific, the antibiotic compound has extremely low solubility to, for example, water under room temperature (20 to 30° C., to be more specific, 25° C.), to be more specific, for example, solubility under room temperature of, on a mass basis, 1 part by mass/100 part by mass of water (10000 ppm) or less, preferably 0.5 parts by mass/100 part by mass of water (5000 ppm) or less, even more preferably 0.1 parts by mass/100 part by mass of water (1000 ppm) or less.

When the antibiotic compound has a water solubility of more than the above-described range, at the time of polymerizing the monomer component, the antibiotic compound easily leaks out to the outside (that is, aqueous phase) of the antibiotic particles, and after the polymerization, the antibiotic compound dissolved in the aqueous phase separates out, and therefore formation of the antibiotic particles in which the antibiotic compound is dispersed in the polymer may become difficult.

These antibiotic compounds can be used singly or in combination of two or more.

The antibiotic compound has a polar term δ_{p,compound} of the solubility parameter δ of, for example, 2 to 8[(J/cm³)^{1/2}], preferably 3 to 7[(J/cm³)^{1/2}], and a hydrogen bonding term δ_{h,compound} of the solubility parameter δ of, for example, 5.5 to 9.5[(J/cm³)^{1/2}], preferably 5.8 to 9.5[(J/cm³)^{1/2}], the solubility parameter δ being calculated by van Krevelen and Hoftyzer method.

Polar term δ_{p,compound} and hydrogen bonding term δ_{h,compound} of the antibiotic compound are described in detail in, for example, Japanese Unexamined Patent Publication No. 2011-79816, and calculation is performed in accordance with the description.

When the monomer component that produces a polymer having a solubility parameter within the above-described range, and the antibiotic compound having a solubility parameter in the above-described range are used, in the produced antibiotic particles, the antibiotic compound are miscible with (dissolved in) the polymer. That is, the controlled-release particles are composed of a homogenous phase of the antibiotic compound and the polymer. To be specific, the controlled-release particles are composed of a homogeneous phase whose composition ratio of the antibiotic compound to the polymer is the same as the composition ratio of the antibiotic compound to the monomer component charged.

The method for producing antibiotic particles of the present invention includes a step of dispersing a hydrophobic solution containing a monomer component and an antibiotic compound in water, and a step of polymerizing the monomer component.

In the step of dispersing the hydrophobic solution in water, first, a hydrophobic solution containing a monomer component and an antibiotic compound is prepared.

The hydrophobic solution is a hydrophobic solution in which an antibiotic compound that is solid under normal temperature is dissolved in a monomer component, or a hydrophobic solution in which an antibiotic compound that is liquid under normal temperature is dissolved in a monomer component.

To be specific, the monomer component and the antibiotic compound are blended, and without blending a solvent (a hydrophobic organic solvent such as hexane, toluene, and ethyl acetate) the mixture is stirred homogeneously, thereby preparing a hydrophobic solution. That is, the monomer component and the antibiotic compound are blended without the presence of a solvent.

The mixing ratio of the antibiotic compound relative to the hydrophobic solution is, for example, 5 to 60 mass %, preferably 10 to 50 mass %. The mixing ratio of the monomer component relative to the hydrophobic solution is, for example, 40 to 95 mass %, preferably 50 to 90 mass %. The mixing ratio (that is, mixing ratio of the antibiotic compound dispersed in 100 parts by mass of the polymer) of the antibiotic compound relative to 100 parts by mass of the monomer component is, for example, 5 to 150 parts by mass, preferably 10 to 100 parts by mass.

An oil-soluble polymerization initiator is blended in the hydrophobic solution along with the monomer component.

Examples of the oil-soluble polymerization initiator include organic peroxides such as dilauroyl peroxide, 1,1,3,3-tetramethylbutylperoxy-2-ethylhexanoate, t-hexylperoxy-2-ethylhexanoate, diisopropylperoxydicarbonate, and benzoyl peroxide; and azo compounds such as 2,2′-azobisisobutyronitrile, 2,2′-azobis(2,4-dimethylvaleronitrile), and 2,2′-azobis(2-methylbutyronitrile). Preferably, organic peroxides are used.

The mixing ratio of the oil-soluble polymerization initiator relative to 100 parts by mass of the monomer component is, for example, 0.01 to 2 parts by mass, preferably 0.1 to 1 parts by mass.

In the step of dispersing the hydrophobic solution in water, then, the hydrophobic solution is dispersed (suspended) in water.

To disperse the hydrophobic solution in water, for example, the hydrophobic solution and water are blended. Preferably, the hydrophobic solution is added to water.

The mixing ratio of water relative to 100 parts by mass of the hydrophobic solution is, for example, 100 to 1000 parts by mass, preferably 105 to 500 parts by mass.

In dispersing the hydrophobic solution in water, as necessary, the dispersing agent and/or surfactant are blended in the hydrophobic solution and/or water. Preferably, the dispersing agent and the surfactant are blended in water.

The dispersing agent is blended as necessary to form protective colloid for the hydrophobic solution during polymerization to improve polymerization stability. To be specific, examples of the dispersing agent include water-soluble polymers such as polyvinyl alcohol, polyvinyl pyrrolidone, gelatin, gum arabic, hydroxyethyl cellulose, hydroxypropyl cellulose, carboxymethyl cellulose, cationized starch, polyacrylic acid and its sodium salt, and styrene maleic acid copolymer and its sodium salt; and inorganic dispersing agents such as tribasic calcium phosphate, colloidal silica, montmorillonite, magnesium carbonate, aluminum hydroxide, and metal oxide (e.g., titanium oxide, zinc oxide, aluminum oxide). Of these examples of the dispersing agent, preferably, inorganic dispersing agents, even more preferably, tribasic calcium phosphate is used.

The dispersing agent includes water-insoluble dispersing agents, or water-soluble dispersing agents are used. When Pickering polymerization to be described later is used, preferably, inorganic dispersing agent, to be specific, tribasic calcium phosphate, titanium oxide, and zinc oxide are used. The water-insoluble dispersing agent is in the form of, for example, particles.

These dispersing agents can be used singly, or can be used in combination of two or more.

The dispersing agent is blended in water in an amount of, for example, 0.1 to 100 parts by mass, preferably 0.1 to 80 parts by mass relative to 100 parts by mass of the hydrophobic solution.

The surfactant is blended as necessary to effectively prevent aggregation of water dispersion particles composed of the hydrophobic solution during polymerization, and to improve polymerization stability. To be specific, for example, anionic surfactants such as the following are used: sodium dialkyl sulfosuccinate such as sodium dioctyl sulfosuccinate, sodium alkyldiphenylethersulfonic acid such as sodium dodecyl diphenyl ether disulphonate, and sodium nonyl diphenyl ether sulfonate, sodium dodecylbenzene sulphonate, sodium lauryl sulfate, polyoxyethylene phosphoric acid ester ammonium salt, and sodium naphthalene sulfonate formaldehyde condensate. Furthermore, non-ionic surfactants such as the following are used: polyoxyethylene lauryl ether, polyoxyethylene nonylphenylether, polyoxyethylene styrenated phenylether, polyoxyethylene monostearate, polyoxyethylene sorbitan monooleate, polyoxyethylene polyoxypropylene block copolymers are used. Preferably, anionic surfactants are used.

These surfactants can be used singly, or can be used in combination of two or more.

The surfactant is blended in water in an amount of, for example, 0.0001 to 1.0 parts by mass, preferably 0.001 to 0.1 parts by mass relative to 100 parts by mass of the hydrophobic solution.

In the water dispersion (suspension) of the hydrophobic solution, for example, a disperser such as homomixer, an ultrasonic homogenizer, a pressurized homogenizer, Milder, or a porous membrane injection disperser is used, and preferably, a homomixer is used.

The above-described water dispersion causes the hydrophobic solution to produce, in water, water dispersion particles having an average particle size (median size) of, for example, 1 μm to 1 mm, preferably 2 μm to 100 μm.

Then, the monomer component in the hydrophobic solution is polymerized. The monomer component is prepared as water dispersion particles having an average particle size of 1 μm to 1 mm, and then polymerized, and therefore the polymerization type is suspension polymerization. In particular, suspension polymerization using a water-insoluble dispersing agent from the above-described dispersing agents, is called Pickering polymerization.

In Pickering polymerization, the water-insoluble dispersing agent in a particle form covers the polymer surface. Thus, by selecting ultraviolet ray absorbing particles as the water-insoluble dispersing agent, compared with the case where a water-soluble dispersing agent is used, the encapsulated antibiotic agent can be protected from ultraviolet ray.

To conduct suspension polymerization, first, the temperature of the aqueous dispersion (suspension liquid) is increased under nitrogen gas current while stirring to, for example, 30 to 100° C., preferably 40 to 80° C., even more preferably 50 to 70° C.

In the suspension liquid during temperature increase, the oil-soluble polymerization initiator undergoes thermal decomposition, which initiates suspension polymerization.

Polymerization time of suspension polymerization is, for example, 1 hour or more, preferably 3 hours or more, even more preferably 4 hours or more, and for example, 10 hours or less.

In the monomer component, under polymerization temperature during suspension polymerization, for example, the polymer (polymer matrix) produced from the monomer component is miscible with (dissolved in) the antibiotic compound. Thus, phase separation is not easily caused during suspension polymerization, the polymer (polymer in the middle of reaction) is dissolved in the antibiotic compound, or polymerization progresses while the polymer (polymer in the middle of reaction) is swelled relative to the antibiotic compound, thereby producing antibiotic particles in which a homogeneous phase is formed.

The antibiotic particles have an average particle size (median size) of, for example, 1 μm or more, preferably 2 μm or more, and for example, 1 mm or less, preferably 100 μm or less.

The antibiotic particles have a shape of, for example, a spherical shape.

Meanwhile, the polymerization type can be mini-emulsion polymerization instead of the above-described suspension polymerization. In such a case, first, in the step of dispersing the hydrophobic solution in water, mini-emulsion particles having an average particle size of, for example, less than below 1 μm, preferably 750 nm or less, and for example, 50 nm or more, preferably 100 nm or more are produced from the hydrophobic solution in water, and then mini-emulsion, in which such mini-emulsion particles are dispersed in water is prepared.

Then, in the step of polymerizing the monomer component, by increasing the temperature of mini-emulsion under the above-described conditions, the mini-emulsion particles are polymerized (mini-emulsion polymerization). In this manner, the antibiotic particles are dispersed in the produced emulsion. The antibiotic particles have an average particle size of, for example, less than 1 μm, preferably 750 nm or less, and for example, 50 nm or more, preferably 100 nm or more.

In mini-emulsion polymerization, generally, the above-described surfactant, and as necessary a dispersing agent are blended in water. For the surfactant, the above-described polymerization reactive emulsifier can also be blended.

The mixing ratio of surfactant relative to 100 parts by mass of the hydrophobic solution is, for example, 0.1 to 20 parts by mass, preferably 0.2 to 10 parts by mass.

For the surfactant, preferably, anionic surfactants are used, even more preferably sodium dialkyl sulfosuccinate, and sodium naphthalene sulfonate formaldehyde condensate are used. For the dispersing agent, preferably, polyvinyl alcohol is used. The surfactant can be dissolved in advance in water at a suitable proportion, and can be prepared as a surfactant-containing aqueous solution. The mixing ratio of the surfactant in the surfactant-containing aqueous solution is, for example, 10 to 90 mass %, preferably 20 to 80 mass %.

The polymerization type can be 2-stage polymerization, to be specific, 2-stage suspension polymerization or 2-stage mini-emulsion polymerization.

That is, a method for producing antibiotic particles including the 2-stage suspension polymerization includes a first step, in which a core material component containing an antibiotic compound and a first polymerizable vinyl monomer is suspension polymerized; and a second step, in which a second polymerizable vinyl monomer having affinity for water of the same as or higher than the first polymerizable vinyl monomer is suspension polymerized.

The first step is the same as the above-described suspension polymerization.

In the second step, first, for example, the suspension liquid (first suspension liquid) after the reaction is cooled. To be specific, the suspension liquid after the reaction is cooled by, for example, allowing the suspension liquid to stand, or by water-cooling. The cooling temperature of the first suspension liquid is, for example, 50° C. or less, preferably 40° C. or less, even more preferably normal temperature or less, and for example, 5° C. or more. Alternatively, the first suspension liquid after the reaction is subjected to, for example, suspension polymerization in the second polymerizable vinyl monomer that follows without cooling.

Then, in the second step, a second polymerizable vinyl monomer is blended in the first suspension liquid, and the mixture is allowed to react.

The second polymerizable vinyl monomer has affinity (that is, hydrophilicity) with water that is higher than that of the first polymerizable vinyl monomer (to be specific, miscible monomer), and to be specific, examples thereof include those monomers that are the same types as those of the above-described first polymerizable vinyl monomers, and that have high affinity with water.

For the second polymerizable vinyl monomer, preferably, alkyl (meth)acrylate is used.

The second polymerizable vinyl monomer is prepared as an emulsified liquid containing the second polymerizable vinyl monomer.

The emulsified liquid is prepared by emulsifying the second polymerizable vinyl monomer in water in the presence of an emulsifier.

Examples of the emulsifier include those surfactants described above. The mixing ratio of the emulsifier relative to 100 parts by mass of the emulsified liquid is, for example, 0.0001 to 1.0 parts by mass, preferably 0.001 to 0.1 parts by mass. The emulsifier can be blended, for example, before or after the blending of the second polymerizable vinyl monomer with water. Preferably, the emulsifier is blended with water before blending with the second polymerizable vinyl monomer. An aqueous solution of the emulsifier is prepared in this manner. The mixing ratio of the second polymerizable vinyl monomer relative to 100 parts by mass of water is, for example, 10 to 1000 parts by mass, preferably 50 to 500 parts by mass. Emulsification time is, for example, 20 minutes or less, preferably for 3 to 20 minutes.

For the preparation of the above-described emulsified liquid, a disperser is used. Preferably, Homo Mixer is used, and its number of revolution is, for example, 200 to 20000 rpm, preferably 1500 to 15000 rpm.

Thereafter, the prepared emulsified liquid is blended with the first suspension liquid, and the mixture is stirred to prepare a second suspension liquid.

In view of allowing the surface of the core composed of the antibiotic compound and the first polymer formed from the first polymerizable vinyl monomer to sufficiently adsorb the second polymerizable vinyl monomer, in preparation of the second suspension liquid, the above-described emulsified liquid is added to the first suspension liquid, and thereafter, stirring is performed for, for example, 0.1 hour or more, preferably 1 hour or more, even more preferably 2 hours or more, and generally 10 hours or less.

In preparation of the second suspension liquid, the second polymerizable vinyl monomer in the emulsified liquid is attached to (absorbed by) the core.

Then, by increasing the temperature of the second suspension liquid, suspension polymerization of the second polymerizable vinyl monomer is performed (second step).

The polymerization temperature in the second step is the same as the polymerization temperature in the first step. The polymerization time in the second step is, for example, 0.1 hour or more, preferably 1 hour or more, even more preferably 2 hours or more, and generally 10 hours or less.

In suspension polymerization, the second polymerizable vinyl monomer is allowed to react while stirring the second suspension liquid so as to maintain the suspension state of the second suspension liquid, thereby producing a polymer (second polymer) of the second polymerizable vinyl monomer.

The suspension polymerization of the second polymerizable vinyl monomer allows covering of the core, and forming of the shell composed of the second polymer.

Thereafter, the second suspension liquid after the reaction is cooled. To be specific, the second suspension liquid is cooled, for example, by allowing the second suspension liquid after the reaction to stand, or by water-cooling. The cooling temperature is, for example, room temperature (20 to 30° C., to be more specific, 25° C.).

After the cooling, the antibiotic compound is present in the first polymer in the core.

That is, when the antibiotic compound is solid at room temperature, in the matrix composed of the first polymer in the core, the miscible (dissolving) state is frozen, and the homogenous state is kept.

Or, after cooling, when the antibiotic compound is liquid at room temperature, the antibiotic compound is miscible with (dissolved in) the first polymer in the core.

By the above-described production method, the suspension liquid including the controlled-release particles having the core and the shell can be obtained.

The particle size of the controlled-release particles is not particularly limited, and the average particle size (median size) is, for example, 1 μm to 1 mm, preferably 2 μm to 100 μm.

The core has a particle size, i.e., an average particle size (median size) of, for example, 1 to 1000 μm, preferably 2 to 50 p.m.

The shell has a thickness, i.e., the maximum thickness of, for example, 0.01 to 500 μm, preferably 0.05 to 50 μm.

In this manner, a suspension liquid in which controlled release particles are suspended can be obtained, the controlled release particles including the core containing the antibiotic compound, and the shell covering the core.

In the controlled-release particles, the core forms a homogeneous phase in which the antibiotic compound and the polymer are miscible (dissolved), and in the entire controlled-release particles, the antibiotic compound is dispersed in the polymer.

The above-described polymerization can be performed twice to be a 2-stage mini-emulsion polymerization.

The mixing ratio of the emulsifier in the first step relative to the hydrophobic solution is, for example, 0.1 to 20 mass %, preferably 0.2 to 10 mass %. The mixing ratio of the dispersing agent is, for example, relative to the hydrophobic solution, for example, 0.1 mass % or more, preferably 0.5 mass % or more, and for example, 10 mass % or less, preferably 6 mass % or less, more preferably 4 mass % or less. The number of revolution of the homomixer is set to, for example, 6000 rpm or more, preferably 8000 rpm or more, even more preferably 10000 rpm or more, and for example, 30000 rpm or less.

The core has a particle size, i.e., an average particle size (median size) of, for example, 20 nm or more, preferably 50 nm or more, and for example, 900 nm or less, preferably 800 nm or less.

The shell has a thickness, i.e., the maximum thickness of, for example, 1 nm or more, preferably 2 nm or more, and for example, 500 nm or less, preferably 400 nm or less.

The IPBC content of the controlled-release particles is, for example, 10 mass % or more, preferably 20 mass % or more, and for example, 50 mass % or less, preferably 40 mass % or less.

Then, to the suspension liquid (in the case of suspension polymerization) or emulsion (in the case of mini-emulsion polymerization) containing the controlled-release particles, as necessary, known additives such as a thickening agent, an antifreezing agent, an antiseptic, a microbial growth inhibitor, and a specific gravity adjuster are blended appropriately.

The thus obtained controlled release particles may be used as is (suspension liquid, emulsion), that is, may be used as suspension formulation (emulsion), or for example, may be formulated into a known form such as powder formulation or granular formulation, after solid-liquid separation by filtration and/or centrifugal separation, etc. and used. As necessary, the controlled release particles can be washed with water and/or acid. Furthermore, the suspension liquid (emulsion) can be dried by spraying or by air as is, to be formulated into forms such as powder formulation or granular formulation.

The suspension formulation or emulsion has a solid content concentration (controlled-release particles concentration) of, for example, 1 to 50 mass %, preferably 5 to 40 mass %.

The suspension formulation or emulsion has an antibiotic compound concentration of, for example, 0.5 to 40 mass %, preferably 1 to 25 mass %.

The thus obtained antibiotic particles may be used as is (suspension liquid, emulsion), that is, may be used as suspension formulation (emulsion), or for example, may be formulated into a known form such as powder formulation or granular formulation, after solid-liquid separation by filtration and/or centrifugal separation, etc. and used. Furthermore, the suspension liquid (emulsion) can be dried by spraying or by air as is, to be formulated into forms such as powder formulation or granular formulation. Furthermore, particularly, the controlled-release particles containing the epoxy group-noncontaining polymerizable vinyl monomer having alkyl (meth)acrylate (to be specific, alkyl acrylate having an alkyl moiety with 2 or more carbon atoms such as, for example, n-BA, alkyl methacrylate having an alkyl moiety with 5 or more carbon atoms such as, for example, methacrylic acid 2-ethylhexyl, etc.) as the second monomer have a low glass transition temperature, and therefore the minimum film-formation temperature (MFT) is low. Therefore, film-formation characteristics are excellent, and thus is used suitably for film-formation.

The suspension formulation (emulsion) has a solid content concentration (antibiotic particles concentration) of, for example, 1 to 50 mass %, preferably 5 to 40 mass %.

The suspension formulation (emulsion) has an antibiotic compound concentration of, for example, 0.5 to 40 mass %, preferably 1 to 25 mass %.

The controlled-release particles have an antibiotic compound concentration of, for example, 10 mass % or more, preferably 20 mass % or more, and for example, 50 mass % or less, preferably 40 mass % or less.

In the antibiotic particles of the present invention, the epoxy group-containing monomer is polymerized, and the polymer contains the epoxy group. To be specific, the epoxy group is chemically bonded to the polymer. To be more specific, the epoxy group is covalently bonded to the polymer. Thus, working environment due to the epoxy group is excellent, and safety for a living body of industrial products to which the antibiotic particles of the present invention are applied (blended) is high.

Furthermore, with the antibiotic particles of the present invention, even if the antibiotic particles are stored, for example, for a long period of time, the polymer contains the epoxy group, and the antibiotic compound is dispersed in the matrix that contains the epoxy group, suppression of discoloration of the same level can be achieved, and particularly, discoloration due to exposure to ultraviolet ray can be reduced because the epoxy group is present near the antibiotic compound to the same level as that of conventional composition containing epoxy low molecular weight compound. Furthermore, safety for a living body is higher compared with a conventional composition containing epoxy low molecular weight compound.

Therefore, the antibiotic particles of the present invention can be applied to various industrial products, and can be applied to (or blended to), for example, indoor/outdoor paint, rubber, fiber, resin, plastic, adhesive, joint mixture, sealing agent, building material, caulking agent, soil treating agent, wood treatment agent, white water in paper-making processes, pigment, treatment liquid for printing plates, cooling water, ink, cutting oil, cosmetic products, nonwoven fabric, spinning oil, and leather. The antibiotic particles are blended such that the amount of the antibiotic compound blended is, for example, 0.001 to 10 mass %, preferably 0.01 to 1 mass %.

### EXAMPLES

In the following, Examples and Comparative Examples of the present invention will be described, but the present invention is not limited thereto.

Details of the abbreviations used in Examples and Comparative Examples are shown below.

IPBC: trade name “Fungitrol 400”, 3-iodo-2-propynylbutylcarbamate, molecular weight 281, melting point: 60° C., water solubility: 150 ppm, polar term δ_{p,compound} of solubility parameter δ: 3.23[(J/cm³)^{/12}], hydrogen bonding term δ_{h,compound} of solubility parameter δ: 7.83[(J/cm³)^{1/2}], manufactured by International Specialty Products Inc.

Methyl methacrylate (MMA): trade name “ACRYESTER M” (“ACRYESTER” is registered trademark), water solubility: 1.6 mass %, polar term δ_{p,monomer} unit of solubility parameter δ as monomer unit: 6.69 [(J/cm³)^{1/2}], hydrogen bonding term δ_{h,monomer unit} of solubility parameter δ as monomer unit: 9.78 [(J/cm³)^{1/2}], manufactured by Mitsubishi Rayon Co., Ltd.

Isobutyl Methacrylate (i-BMA): water solubility: 0.06 mass %, polar term δ_{p,monomer unit} of solubility parameter δ as monomer unit: 3.75 [(J/cm³)^{/12}], hydrogen bonding term δ_{h,monomer unit} of solubility parameter δ as monomer unit: 7.32[(J/cm³)^{1/2}], manufactured by Nippon Shokubai Co., Ltd.

Methacrylic acid (MAA): water solubility: 8.9 mass %, polar term δ_{p,monomer unit} of solubility parameter δ as monomer unit: 7.13 [(J/cm³)^{1/2}], hydrogen bonding term δ_{h,monomer unit} of solubility parameter δ as monomer unit: 13.03[(J/cm³)^{1/2}], manufactured by Mitsubishi Rayon Co., Ltd.

N-butyl acrylate (n-BA): water solubility: 0.14 mass %, polar term δ_{p,monomer unit} of solubility parameter δ as monomer unit: 4.26 [(J/cm³)^{1/2}], hydrogen bonding term δ_{h,monomer unit} of solubility parameter δ as monomer unit: 7.81 [(J/cm³)^{1/2}], manufactured by Mitsubishi Rayon Co., Ltd.

2-[3-(2H-benzotriazole-2-yl)-4-hydroxyphenyl]ethyl methacrylate: trade name “RUVA-93”, polymerization reactive ultraviolet absorber, water solubility: 0.1 g/100 ml or less, polar term δ_{p,monomer unit} of solubility parameter δ as monomer unit: 5.61 [(J/cm³)^{1/2}], hydrogen bonding term δ_{h,monomer unit} of solubility parameter δ as monomer unit: 13.07 [(J/cm³)^{1/2}], Tokyo Chemical Industry Co., Ltd.

Polymerization reactive emulsifier: trade name “ELEMINOL RS-3000”, methacryloyloxypolyoxypropylenesulfatesodium salt (anionic emulsifier having a nonionic hydrophilic group) 50% aqueous solution, manufactured by Sanyo Chemical

Glycidyl methacrylate (GMA): trade name “BLEMMER G” (“BLEMMER” is registered trademark), water solubility: 0.5 to 1.0 mass %, polar term δ_{p,monomer unit} of solubility parameter δ as monomer unit: 6.18[(J/cm³)^{1/2}], hydrogen bonding term δ_{h,monomer unit} of solubility parameter δ as monomer unit: 9.24[(J/cm³)^{1/2}], manufactured by NOF CORPORATION

Ethylene glycol dimethacrylate (EGDMA): trade name “Light Ester EG”, water solubility: 5.37 ppm, polar term δ_{p,monomer unit} of solubility parameter δ as monomer unit: 5.37[(J/cm³)^{1/2}], hydrogen bonding term δ_{h,monomer unit} unit of solubility parameter δ as monomer unit: 10.42[(J/cm³)^{1/2}], manufactured by Kyoeisha Chemical Co., Ltd.

Dilauroyl peroxide: trade name “PEROYL L” (“PEROYL” is registered trademark), oil-soluble polymerization initiator, manufactured by NOF CORPORATION

TCP-10U: trade name, a suspension liquid of 10 mass % tribasic calcium phosphate [Ca₃(PO₄)₂].Ca(OH)₂, manufactured by Matsuo Yakuhin Sangyo K. K.

JR-805: trade name, titanium oxide particles, crystal system: rutile, spherical, average particle size: 0.29 μm, surface treated, Al.Si, TiO₂ purity: >88 mass %, manufactured by TAYCA

PLYSURF A210G: trade name, (“PLYSURF” is registered trademark), polyoxyethylene phosphate ammonium salt, anionic surfactant, manufactured by DAI-ICHI KOGYO SEIYAKU CO., LTD.

NEOCOL SW-C: trade name (“NEOCOL” is registered trademark), solution of 70 mass % sodium dioctyl sulfosuccinate (anionic surfactant) in isopropanol, manufactured by Dai-ichi Kogyo Seiyaku Co., Ltd.

DEMOL NL: trade name, aqueous solution of 51 mass % β-sodium naphthalene sulfonate formaldehyde condensate (anionic surfactant), manufactured by Kao Corporation

PVA 205: trade name, polyvinyl alcohol, the degree of saponification: 87.0 to 89.0%, degree of polymerization: 500, viscosity (4% aqueous solution, 20° C.): 5.0 to 6.0 mPa·sec, manufactured by Kuraray Co., Ltd.

NOIGEN EA-177: trade name (“NOIGEN” is registered trademark), polyoxyethylene styrenated phenylether (non-ionic surfactant), manufactured by Dai-ichi Kogyo Seiyaku Co., Ltd.

OROTAN 731SD: trade name (“OROTAN” is registered trademark), sodium polycarboxylate, dispersing agent, manufactured by Rohm and Haas Company

Emulgen A-90: trade name (“Emulgen” is registered trademark), polyoxyethylene distyrenated phenylether, non-ionic surfactant, manufactured by Kao Corporation

Nopco DF-122: trade name, antifoaming agent, manufactured by San Nopco Limited

TIPAQUE UT-771: trade name (“TIPAQUE” is registered trademark), titanium oxide, white pigment, manufactured by Ishihara Sangyo Kaisha, Ltd.

Ultrazole A-20: trade name (“Ultrazole” is registered trademark), acrylic emulsion, manufactured by Gants Chemical Co., Ltd.

METOLOSE 60SII-10000: trade name (“METOLOSE” is registered trademark), hydroxypropyl methylcellulose, manufactured by Shin-Etsu Chemical Co., Ltd.

### Example 1

A 200 mL beaker (1) was charged with 37.5 g of IPBC, 63.8 g of methyl methacrylate, 15.0 g of glycidyl methacrylate, 33.8 g of ethylene glycol dimethacrylate, and 0.8 g of dilauroyl peroxide, and the mixture was stirred homogeneously at room temperature, thereby preparing a hydrophobic solution.

Separately, a 1000 mL beaker (2) was charged with 164.0 g of ion-exchange water, 60.0 g of TCP-10U, and 0.3 g of 5 mass % aqueous solution of PLYSURF A210G, and the mixture was stirred homogeneously at room temperature, thereby producing a suspension liquid.

Then, a hydrophobic solution was added to the 1000 mL beaker (2), and the mixture was stirred with T.K. Homo Mixer MARK 2.5 type (manufactured by PRIMIX Corporation) at a number of revolution of 3500 rpm for 5 minutes, thereby suspending the hydrophobic solution homogeneously, and preparing a suspension liquid.

Thereafter, the suspension liquid was transferred to a 500 mL, four-neck flask equipped with a stirrer, reflux condenser, thermometer, and nitrogen inlet tube, and its temperature was increased while stirring under nitrogen gas current, thereby polymerizing the suspension liquid (Pickering polymerization).

The pickering polymerization was started when the temperature of the suspension liquid reached 55° C. while increasing the temperature of the suspension liquid, and then the temperature of the suspension liquid was kept at 70° C. for 6 hours.

Thereafter, the suspension liquid was cooled to room temperature.

A suspension liquid of IPBC-containing particles having an average particle size of 19.0 μm was obtained in this manner.

### Example 2

A suspension liquid of IPBC-containing particles was produced in the same manner as in Example 1, except that in the hydrophobic solution, the amount of methyl methacrylate blended was changed from 63.8 g to 41.3 g, and the amount of glycidyl methacrylate blended was changed from 15.0 g to 37.5 g.

### Example 3

A suspension liquid of IPBC-containing particles was produced in the same manner as in Example 1, except that in preparation of the hydrophobic solution, methyl methacrylate was not blended, and the amount of ethylene glycol dimethacrylate blended was changed from 33.8 g to 97.6 g.

### Example 4

A 200 mL beaker (1) was charged with 40.0 g of IPBC, 76.0 g of isobutyl methacrylate, 40.0 g of glycidyl methacrylate, 4.0 g of methacrylic acid, and 2.4 g of dilauroyl peroxide, and the mixture was stirred homogeneously at room temperature, thereby preparing a hydrophobic solution.

Separately, a 1000 mL beaker (2) was charged with 200.8 g of ion-exchange water, 4.0 g of NEOCOL SW-C, and 20.0 g of a 25 mass % aqueous solution of NOIGEN EA-177, and the mixture was stirred homogeneously at room temperature, thereby producing a surfactant-containing aqueous solution.

Then, a hydrophobic solution was added to the 1000 mL beaker (2), and the mixture was stirred with T.K. Homo Mixer MARK 2.5 type (manufactured by PRIMIX Corporation) at a number of revolution of 12000 rpm for 5 minutes, thereby dispersing the hydrophobic solution in water, and preparing a mini-emulsion.

Thereafter, the mini-emulsion was transferred to a 500 mL four-neck flask equipped with a stirrer, reflux condenser, thermometer, and nitrogen inlet tube, and its temperature was increased while stirring under nitrogen gas current, thereby polymerizing the mini-emulsion (mini-emulsion polymerization).

The mini-emulsion polymerization was started when the temperature of the mini-emulsion reached 55° C. while increasing the temperature of the mini-emulsion, and then the temperature of the mini-emulsion was kept at 70° C. for 2 hours.

Thereafter, the reaction solution was cooled to room temperature.

The emulsion of IPBC-containing particles was obtained in this manner.

### Example 5

A 200 mL beaker (1) was charged with 25.0 g of IPBC, 42.5 g of methyl methacrylate, 10.0 g of glycidyl methacrylate, 22.5 g of ethylene glycol dimethacrylate, and 0.5 g of dilauroyl peroxide, and the mixture was stirred homogeneously at room temperature, thereby preparing a hydrophobic solution.

Separately, a 1000 mL beaker (2) was charged with 228.0 g of ion-exchange water, 48.0 g of JR-805, and 4.0 g of a 5% aqueous solution of PLYSURF A210G, and the mixture was stirred homogeneously with T.K. Homo Mixer MARK 2.5 type (manufactured by PRIMIX Corporation) at a number of revolution of 5000 rpm for 5 minutes, thereby producing a suspension liquid.

Then, a hydrophobic solution was added to the 1000 mL beaker (2), and the mixture was stirred with T.K. Homo Mixer MARK 2.5 type (manufactured by PRIMIX Corporation) at a number of revolution of 5000 rpm for 5 minutes, thereby suspending the hydrophobic solution homogeneously, and preparing a suspension liquid.

Thereafter, the suspension liquid was transferred to a 500 mL four-neck flask equipped with a stirrer, reflux condenser, thermometer, and nitrogen inlet tube, and its temperature was increased while stirring under nitrogen gas current, thereby polymerizing the suspension liquid (Pickering polymerization).

The pickering polymerization was started when the temperature of the suspension liquid reached 55° C. while increasing the temperature of the suspension liquid, and then the temperature of the suspension liquid was kept at 70° C. for 6 hours.

Thereafter, the suspension liquid was cooled to room temperature.

A suspension liquid of IPBC-containing particles was obtained in this manner.

### Example 6

A suspension liquid of IPBC-containing particles was produced in the same manner as in Example 5, except that 1.0 g of a 5 mass % aqueous solution of PLYSURF A210G was introduced to the 1000 mL beaker (2), and in the hydrophobic solution, the amount of methyl methacrylate blended was changed from 42.5 g to 27.5 g, and the amount of glycidyl methacrylate blended was changed from 10.0 g to 25.0 g.

### Example 7

A suspension liquid of IPBC-containing particles was produced in the same manner as in Example 1, except that in preparation of the hydrophobic solution, methyl methacrylate and ethylene glycol dimethacrylate were not blended, and the amount of glycidyl methacrylate blended was changed from 15.0 g to 100.0 g.

### Comparative Example 1

A suspension liquid of IPBC-containing particles was produced in the same manner as in Example 1, except that the amount of methyl methacrylate blended in the hydrophobic solution was changed from 63.8 g to 78.8 g, and glycidyl methacrylate was not blended.

### Comparative Example 2

An emulsion of IPBC-containing particles was produced in the same manner as in Example 4, except that the amount of isobutyl methacrylate in the hydrophobic solution was changed from 76.0 g to 116.0 g, and glycidyl methacrylate was not blended.

### Comparative Example 3

A suspension liquid of IPBC-containing particles was produced in the same manner as in Example 5, except that the amount of methyl methacrylate blended in the hydrophobic solution was changed from 42.5 g to 52.5 g, and glycidyl methacrylate was not blended.

### Example 8

### Production of Controlled Release Particles Containing IPBC by Mini-Emulsion Polymerization

A 200 mL container was charged with 33.3 g of IPBC, 74.0 g of methyl methacrylate, 13.3 g of glycidyl methacrylate, 6.0 g of ethylene glycol dimethacrylate, 6.7 g of 2-[3-(2H-benzotriazole-2-yl)-4-hydroxyphenyl]ethyl methacrylate, and 0.7 g of PEROYL L, and the mixture was stirred at room temperature, thereby preparing a homogeneous hydrophobic solution.

Separately, a 500 mL beaker was charged with 135.7 g of deionized water, 53.3 g of an aqueous solution of PVA205 (10%), 1.1 g of NEOCOL SW-C, and 0.3 of DEMOL NL, and the mixture was stirred at room temperature, thereby preparing a homogeneous aqueous emulsifier solution.

Next, a hydrophobic solution was added to the aqueous emulsifier solution in the 500 mL beaker, and the mixture was stirred with T.K. Homo Mixer MARK 2.5 type (manufactured by PRIMIX Corporation) at a number of revolution of 10000 rpm for 10 min, thereby emulsifying the hydrophobic solution in the aqueous emulsifier solution, and preparing a mini-emulsion.

Thereafter, the prepared mini-emulsion was transferred to a 500 mL four-neck flask equipped with a stirrer, reflux condenser, thermometer, and nitrogen inlet tube, and the temperature of the four-neck flask was increased with water bath while stirring the mixture with a 6 cm-diameter stirrer at a number of revolution of 200 rpm (circumferential speed 37.8 m/min) under nitrogen gas current, thereby conducting mini-emulsion polymerization.

The mini-emulsion polymerization was regarded as initiated when the temperature reached 55° C., and thereafter, polymerization was performed continuously for 3 hours at 60±2° C., and for 2 hours at 70±2° C.

Then, the temperature of the water bath was increased, and the temperature of the reaction solution was increased to 80° C.±2° C., and aging was performed at the temperature for 2 hours.

Thereafter, the reaction solution was cooled to 30° C. or less, thereby producing an emulsion of controlled release particles containing IPBC. After the emulsion was filtered with a filter cloth having 100 pores, the median size of the controlled-release particles in the filtrate was measured: the median size of the controlled-release particles was 434 nm.

The emulsion was a colloidal dispersion stable as a normal polymer latex, and no tendency of sedimentation or phase separation of the particles was observed during storage at room temperature.

### Example 9

An emulsion was produced in the same manner as in Example 8, except that in the hydrophobic solution, the amount of methyl methacrylate blended was changed from 74.0 g to 56.9 g, the amount of glycidyl methacrylate blended was changed from 13.3 g to 10.3 g, the amount of ethylene glycol dimethacrylate blended was changed from 6.0 g to 4.6 g, and furthermore, 2-[3-(2H-benzotriazole-2-yl)-4-hydroxyphenyl]ethyl methacrylate was not blended.

Furthermore, a 100 mL container was charged with 25.6 g of methyl methacrylate and 2.6 g of 2-[3-(2H-benzotriazole-2-yl)-4-hydroxyphenyl]ethyl methacrylate, and the mixture was stirred at room temperature, thereby preparing a homogeneous hydrophobic solution.

Separately, a 200 mL beaker was charged with 25.6 g of deionized water and 0.1 g of NEOCOL SW-C, and the mixture was stirred at room temperature, thereby preparing a homogeneous aqueous emulsifier solution.

Next, a hydrophobic solution was added to the aqueous emulsifier solution in the 200 mL beaker, and the mixture was stirred with T.K. Homo Mixer MARK 2.5 type (manufactured by PRIMIX Corporation) at a number of revolution of 10000 rpm for 10 min, thereby emulsifying the hydrophobic solution in the aqueous emulsifier solution, and preparing a mini-emulsion.

The aforementioned mini-emulsion was added while stirring the emulsion, and the mixture was stirred for 2 hours.

Thereafter, the temperature was increased while stirring under nitrogen gas current, and polymerization was performed at 70° C. for 3 hours while stirring.

Thereafter, the reaction solution was cooled to 30° C. or less, thereby producing an emulsion of controlled release particles containing IPBC. After the emulsion was filtered with a filter cloth having 100 pores, the median size of the controlled-release particles in the filtrate was measured: the median size of the controlled-release particles was 303 nm.

The emulsion was a colloidal dispersion stable as a normal polymer latex, and no tendency of sedimentation or phase separation of the particles was observed during storage at room temperature.

### Example 10 to Example 15 and Comparative Examples 4 and 5

An emulsion of controlled-release particles was produced in the same manner as in Example 8, except that the mixing formulation and the conditions of the components were changed in conformity with Table 2.

Any of the emulsions of Example 10 to Example 15 and Comparative Example 4 and 5 was a colloidal dispersion liquid stable as a normal polymer latex, and no tendency of sedimentation or phase separation of the particles was observed during storage at room temperature.

### Evaluation Test Method

### 1. Discoloration Test

A white aqueous emulsion paint was prepared by blending 857.5 g of ion-exchange water, 329.1 g of a 25 mass % aqueous solution of OROTAN 731SD, 20.4 g of Emulgen A-90, 85.8 g of Nopco DF-122, 2042.5 g of TIPAQUE UT-771, 4487.8 g of Ultrazole A-20, and 730.08 g of 1 mass % aqueous solution of METOLOSE 60SH-10000. The suspension liquid (or emulsion) of Examples and Comparative Examples was added to the white aqueous emulsion paint so that the IPBC content was 5000 ppm, and the mixture was stirred with Disper at 1000 rpm for 1 hour, thereby preparing a paint for evaluation.

The paint for evaluation was applied on an aluminum plate (JIS A 1050P1, 20 mm×20 mm) using a bar coater, thereby forming a film.

The film was dried at 40° C. for 24 hours, and was cut to give a size of 70 mm×150 mm, thereby producing a test piece. The test piece was attached to Dewpanel Weather Meter, and exposed to ultraviolet ray irradiation for 1 week.

Thereafter, the b-value of the exposed test piece was measured by using a colorimeter. The unexposed test pieces were also measured.

The change (Δb) in b-value was calculated from the b-values of the exposed and unexposed test pieces. The results are shown in Tables 1 and 2.

In Table 1 and Table 2, the mixing ratio (parts by mass) of the each composition is shown by setting the total amount of the monomer components as 100 parts by mass.

TABLE 1

| | | Exam- | Exam- | Exam- | Exam- | Exam- | Exam- | Exam- | Comp. | Comp. | Comp. |
|---|---|---|---|---|---|---|---|---|---|---|---|
| | | ple 1 | ple 2 | ple 3 | ple 4 | ple 5 | ple 6 | ple 7 | Ex. 1 | Ex. 2 | Ex. 3 |
| Hydro- | IPBC | 33.3 | 33.3 | 33.3 | 33.3 | 33.3 | 33.3 | 33.3 | 33.3 | 33.3 | 33.3 |
| phobic | Monomer Components | 100.0 | 100.0 | 100.0 | 100.0 | 100.0 | 100.0 | 100.0 | 100.0 | 100.0 | 100.0 |
| Solution | In Total | | | | | | | | | | |

| | | | | | | | | | | |
|---|---|---|---|---|---|---|---|---|---|---|
| Methyl | 56.7 | 36.7 | — | — | 56.7 | 36.7 | — | 70.0 | — | 70.0 |
| methacrylate | | | | | | | | | | |
| (MMA) | | | | | | | | | | |
| Isobutyl | — | — | — | 63.4 | — | — | — | — | 96.7 | — |
| Methacrylate | | | | | | | | | | |
| (i-BMA) | | | | | | | | | | |
| Methacrylic | — | — | — | 3.3 | — | — | — | — | 3.3 | — |
| acid (MAA) | | | | | | | | | | |
| Glycidyl | 13.3 | 33.3 | 13.3 | 33.3 | 13.3 | 33.3 | 100.0 | — | — | — |
| methacrylate | | | | | | | | | | |
| (GMA) | | | | | | | | | | |
| Ethylene glycol | 30.0 | 30.0 | 86.7 | — | 30.0 | 30.0 | — | 30.0 | — | 30.0 |
| dimethacrylate | | | | | | | | | | |
| (EGDMA) | | | | | | | | | | |

| | | | | | | | | | | | |
|---|---|---|---|---|---|---|---|---|---|---|---|
| | Dilauroyl peroxide | 0.7 | 0.7 | 0.7 | 2.0 | 0.7 | 0.7 | 0.7 | 0.7 | 2.0 | 0.7 |
| | (PEROYL L) | | | | | | | | | | |
| Water | Ion-exchange water | 145.6 | 145.6 | 145.6 | 167.3 | 304.0 | 304.0 | 145.6 | 145.6 | 167.3 | 304.0 |
| | TCP-10U | 53.3 | 53.3 | 53.3 | — | — | — | 53.3 | 53.3 | — | — |
| | JR-805 | — | — | — | — | 64.0 | 64.0 | — | — | — | 64.0 |
| | PLYSURF A210G(5% | 0.3 | 0.3 | 0.3 | — | 5.3 | 5.3 | 0.3 | 0.3 | — | 5.3 |
| | aqueous solution) | | | | | | | | | | |
| | NEOCOL SW-C | — | — | — | 3.3 | — | — | — | — | 3.3 | — |
| | NOIGEN EA-177(25% | — | — | — | 16.7 | — | — | — | — | 16.7 | — |
| | aqueous solution) | | | | | | | | | | |

| Total | 333.2 | 333.2 | 333.1 | 322.6 | 507.3 | 507.3 | 333.2 | 333.2 | 322.6 | 507.3 |
|---|---|---|---|---|---|---|---|---|---|---|
| IPBC concentration[vs | 33.3 | 33.3 | 33.3 | 33.3 | 33.3 | 33.3 | 33.3 | 33.3 | 33.3 | 33.3 |
| Controlled release particles](%) | | | | | | | | | | |
| Particle size (μm) | 23.4 | 20.8 | 21.3 | 0.333 | 10.0 | 11.8 | 22.8 | 15.7 | 0.374 | 12.3 |
| δp of polymer matrix[(J/cm³)^{1/2}] | 6.03 | 6.38 | 5.69 | 5.19 | 6.03 | 6.38 | 6.18 | 5.80 | 3.87 | 5.80 |
| δh of polymer matrix [(J/cm³)^{1/2}] | 9.74 | 9.96 | 10.41 | 8.52 | 9.74 | 9.96 | 9.24 | 9.60 | 7.51 | 9.60 |
| Polymerization method | Pickering | | | Mini- | Pickering | | | | Mini- | Pickering |
| | polymer- | | | emulsion | polymer- | | | | emulsion | polymer- |
| | ization | | | polymer- | ization | | | | polymer- | ization |
| | | | | ization | | | | | ization | |
| Discoloration Test(Δb) | 9 | 6 | 11 | 9 | 8 | 8 | 11 | 13 | 14 | 14 |

TABLE 2

| | | Exam- | Exam- | Exam- | Exam- | Exam- | Exam- | Exam- | Exam- | Comp. | Comp. |
|---|---|---|---|---|---|---|---|---|---|---|---|
| | | ple 8 | ple 9 | ple 10 | ple 11 | ple 12 | ple 13 | ple 14 | ple 15 | Ex. 4 | Ex. 5 |
| Hydro- | IPBC | 33.3 | 30.8 | 33.3 | 33.3 | 33.3 | 33.3 | 50.0 | 33.3 | 33.3 | 33.3 |
| phobic | Total amount of | 100.0 | 71.8 | 100.0 | 100.0 | 105.0 | 100.0 | 100.0 | 100.0 | 100.0 | 100.0 |
| Solution | monomer component | | | | | | | | | | |

| | | | | | | | | | | |
|---|---|---|---|---|---|---|---|---|---|---|
| Methyl | 74.0 | 56.9 | 86.7 | 80.7 | 80.7 | 80.7 | 80.7 | 46.1 | 94.0 | 100.0 |
| methacrylate (MMA) | | | | | | | | | | |
| Isobutyl | — | — | — | — | — | — | — | — | — | — |
| Methacrylate (i-BMA) | | | | | | | | | | |
| Butyl acrylate | — | — | — | — | — | — | — | 34.6 | | |
| (n-BA) | | | | | | | | | | |
| Methacrylic | | | | | | | | | | |
| acid (MAA) | | | | | | | | | | |
| Glycidyl | 13.3 | 10.3 | 13.3 | 13.3 | 13.3 | 13.3 | 13.3 | 13.3 | — | — |
| methacrylate (GMA) | | | | | | | | | | |
| Ethylene glycol | 6.0 | 4.6 | — | 6.0 | 6.0 | 6.0 | 6.0 | 6.0 | 6.0 | — |
| dimethacrylate | | | | | | | | | | |
| (EGDMA) | | | | | | | | | | |
| Methacrylic acid | 6.7 | — | — | — | — | — | — | — | — | — |
| 2-[3-(2H-benzotriazole-2- | | | | | | | | | | |
| yl)-4-hydroxyphenyl] ethyl | | | | | | | | | | |
| Polymerization | — | — | — | — | 5.0 | — | — | — | | |
| reactive emulsifiers | | | | | | | | | | |

| | | | | | | | | | | | |
|---|---|---|---|---|---|---|---|---|---|---|---|
| | Dilauroyl peroxide | 0.7 | 0.5 | 0.7 | 0.7 | 0.7 | 0.7 | 0.7 | 0.7 | 0.7 | 0.7 |
| | (PEROYL L) | | | | | | | | | | |
| Water | Ion-exchange water | 135.7 | 104.4 | 135.7 | 135.7 | 135.7 | 55.5 | 135.7 | 135.7 | 135.7 | 135.7 |
| | TCP-10U | — | — | — | — | — | — | — | — | — | — |
| | JR-805 | — | — | — | — | — | — | — | — | — | — |
| | PVA205(10% | 53.3 | 41.0 | 53.3 | 53.3 | 53.3 | 53.3 | 53.3 | 53.3 | 53.3 | 53.3 |
| | aqueous solution) | | | | | | | | | | |
| | PLYSURF A210G(5% | — | — | — | — | — | — | — | — | — | — |
| | aqueous solution). | | | | | | | | | | |
| | NEOCOL SW-C | 1.1 | 0.8 | 1.1 | 1.1 | — | 1.1 | 1.1 | 1.1 | 1.1 | 1.1 |
| | NOIGEN EA-177(25% | — | — | — | — | — | — | — | — | — | — |
| | aqueous solution) | | | | | | | | | | |
| | DEMOL NL | 0.3 | 0.2 | 0.3 | 0.3 | — | 0.3 | 0.3 | 0.3 | 0.3 | 0.3 |
| Hydro- | Methyl methacrylate | — | 25.6 | — | — | — | — | — | — | — | — |
| phobic | (MMA) | | | | | | | | | | |
| Solution | Methacrylic acid | — | 2.6 | — | — | — | — | — | — | — | — |
| | 2-[3-(2H-benzotriazole-2- | | | | | | | | | | |
| | yl)-4-hydroxyphenyl] ethyl | | | | | | | | | | |
| Water | Ion-exchange water | — | 25.6 | — | — | — | — | — | — | — | — |
| | NEOCOL SW-C | — | 0.1 | — | — | — | — | — | — | — | — |

| Total | 324.4 | 303.4 | 324.4 | 324.4 | 328.0 | 244.2 | 341.1 | 324.4 | 324.4 | 324.4 |
|---|---|---|---|---|---|---|---|---|---|---|
| IPBC concentration[vs | 35.7 | 42.9 | 33.3 | 33.3 | 33.3 | 33.3 | 50.0 | 33.3 | 33.3 | 33.3 |
| Controlled release particles] | | | | | | | | | | |
| Particle size (nm) | 434 | 414 | 381 | 378 | 455 | 324 | 436 | 431 | 408 | 390 |
| δp of polymer matrix [(J/cm³)^{1/2}] | 5.95 | 6.20 | 6.22 | 6.18 | ~6.2 | 6.18 | 6.18 | 5.98 | 5.95 | 5.98 |
| δh of polymer matrix [(J/cm³)^{1/2}] | 9.09 | 9.48 | 9.39 | 9.46 | ~9.5 | 9.46 | 9.46 | 8.96 | 9.32 | 9.25 |
| Polymerization method | Mini- | Two-step | Mini- | | | | | | | |
| | emulsion | Mini- | emulsion | | | | | | | |
| | polymer- | emulsion | polymer- | | | | | | | |
| | ization | polymer- | ization | | | | | | | |
| | | izatio | | | | | | | | |
| Discoloration Test(Δb) | 3 | 2 | 5 | 5 | 5 | 6 | 6 | 5 | 18 | 20 |

### 2. Evaluation on Antifungal Characteristics (Mildewproof Characteristics and Yeastproof Characteristics)

The suspension liquid of the IPBC-containing particles of Example 1, Example 8, and Example 9 was added to glucose broth agar medium (pH6.0), and thereafter, using a microplanter (manufactured by SAKUMA SEISAKUSHO KK), a mildew suspension liquid containing mildews shown in Table 3 and yeast were inoculated, and cultured at 28° C. for 3 days.

Thereafter, growth of fungal hyphae after the culture was observed, and their minimum inhibitory concentration (MIC: μg/mL) was calculated.

The results are shown in Table 3.

TABLE 3

| | Minimum inhibitory | | |
|---|---|---|---|
| | concentration (μg/ml) | | |
| | Example 1 | Example 8 | Example 9 |
| Aspergillus niger | <2.0 | <2.0 | <2.0 |
| Penicillium citrinum | 15.3 | 15.6 | 15.6 |
| Cladosporium cladosporioides | 3.9 | 7.8 | 7.8 |
| Aureobasidium pullulans | <2.0 | <2.0 | <2.0 |
| Alternaria sp. | 3.9 | 7.8 | 7.8 |
| Mucor spinescens | 15.6 | 15.6 | 15.6 |
| Gliocladium virens | 15.6 | 31.2 | 31.2 |
| Rhodotorula rubra | 15.6 | 31.2 | 31.2 |
| Saccharomyces cerevisiae | 7.8 | 15.6 | 15.6 |

Details of the mildews and yeasts used in the minimum inhibitory concentration test shown in Table 3 are described below.

### <Mildews>

Aspergillus niger
Penicillium citrinum
Cladosporium cladosporioides
Aureobasidium pullulans
Alternaria sp.
Mucor spinescens
Gliocladium virens

### <Yeasts>

Rhodotorula rubra
Saccharomyces cerevisiae

### 3. Evaluation in Skin Sensitization

A suspension liquid of IPBC-containing particles of Example 1 was dried at 25° C. for 24 hours, thereby producing IPBC-containing particles in a powder state.

The particles were evaluated based on Buehler Test in OECD GUIDELINES FOR TESTING OF CHEMICALS (Test No. 406), and the results were negatives.

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The antibiotic particles can be applied to various industrial products, for example, indoor/outdoor paint, rubber, fiber, resin, plastic, adhesive, joint mixture, sealing agent, building material, caulking agent, soil treating agent, wood, white water in paper-making processes, pigment, treatment liquid for printing plates, cooling water, ink, cutting oil, cosmetic products, nonwoven fabric, spinning oil, and leather.

1. Antibiotic particles in which an antibiotic compound is dispersed in a polymer containing an epoxy group.

2. The antibiotic particles according to claim 1, wherein the polymer is produced by polymerizing a monomer component containing an epoxy group-containing monomer.

3. Antibiotic particles produced by dispersing a hydrophobic solution containing an antibiotic compound and a monomer component containing an epoxy group-containing monomer in water, and polymerizing the monomer component.

4. A method for producing antibiotic particles, the method including the steps of:
dispersing a hydrophobic solution containing an antibiotic compound and a monomer component containing an epoxy group-containing monomer in water, and
polymerizing the monomer component.
